(19) United States
(12) Patent Application Publication
(10) Pub. No.: US 2011/0072592 A1
(43) Pub. Date: Mar. 31, 2011

(54) AUTO BODY TOOL

(76) Inventor: John K. Toth, Flemington, NJ (US)

(21) Appl. No.: 12/568,693

(22) Filed: Sep. 29, 2009

(51) Int. Cl. B25B 27/00; B25D 3/00

(52) U.S. Cl. 7/100; 30/167

(57) ABSTRACT

Disclosed herein is an auto body tool for the removal of quarter panels. The auto body tool includes a shank, a chisel and a shoulder against which hammering forces can be applied. The shoulder includes a flat beating surface and a slanted surface that together form a right triangle with the shank. The chisel extends at an angle from the shank to provide ease of access to the proper location against which prying and hammering forces can be applied.

### FIELD OF THE INVENTION

The present invention relates to an automobile tool for auto body repairs. Specifically, the present invention relates to a tool that facilitates the removal of automobile rear quarter panels.

### BACKGROUND OF THE INVENTION

On an automobile, a quarter-panel is a body panel that typically covers the section between the rear door and the trunk. It is typically made of sheet metal, but is sometimes made of fiberglass and fiber-reinforced plastic. The quarter-panel typically wraps between a vehicle's door and hood, or the door and trunk, and can be welded to the wheel arch assembly. The panel between a car's front door and the hood is typically held in place by means of a bolt, rather than by welds. The real quarter panel is many times replaced rather than repaired. The panel is designed differently for various types of vehicles, and has different sizes and lengths.

In order to remove the quarter panel, the spot welds must be broken. Typically, a drill is used to break the welds, then a chisel is used to split apart the metal panels. However, prying apart the metal layers using a standard chisel or a crowbar can be difficult because of the position required to access the area of interest and lack of an area on a chisel against which force can be applied. A need exists for a tool that improves an auto body worker's ability to remove quarter panels.

### SUMMARY OF THE INVENTION

The present invention overcomes the disadvantages and shortcomings of the problems of the prior art by providing a tool that allows access of a chisel to the areas in between metal layers after the spot welds have been removed in a configuration that makes prying the layers apart more easy to accomplish. More specifically, the present invention provides a tool that includes a chisel at one end that is sufficiently bent away from the shank to fit into the desired space. The present invention also provides a shoulder segment that in combination with the shank essentially forms a right triangular shape which a worker can apply a hammering force to help him pry off the desire pieces of metal.

### BRIEF DESCRIPTION OF THE DRAWINGS

For a more complete understanding of the present invention, reference is made to the following detailed description of the exemplary embodiment(s) considered in conjunction with the accompanying drawing in which:

FIG. 1 is a perspective view of an auto body tool constructed in accordance with an embodiment of the present invention;

FIG. 2 is a right side elevational view of the auto body tool shown in FIG. 1, a left side elevational view being a mirror image thereof;

FIG. 3 is a top plan view of the auto body tool shown in FIG. 1;

FIG. 4 is a bottom plan view of the auto body tool shown in FIG. 1;

FIG. 5 is a front elevational view of the auto body tool shown in FIG. 1;

FIG. 6 is a rear elevational view of the auto body tool shown in FIG. 1; and

FIG. 7 is a perspective view showing the auto body tool as it would be used in conjunction with an automobile.

### DETAILED DESCRIPTION OF THE EXEMPLARY EMBODIMENTS

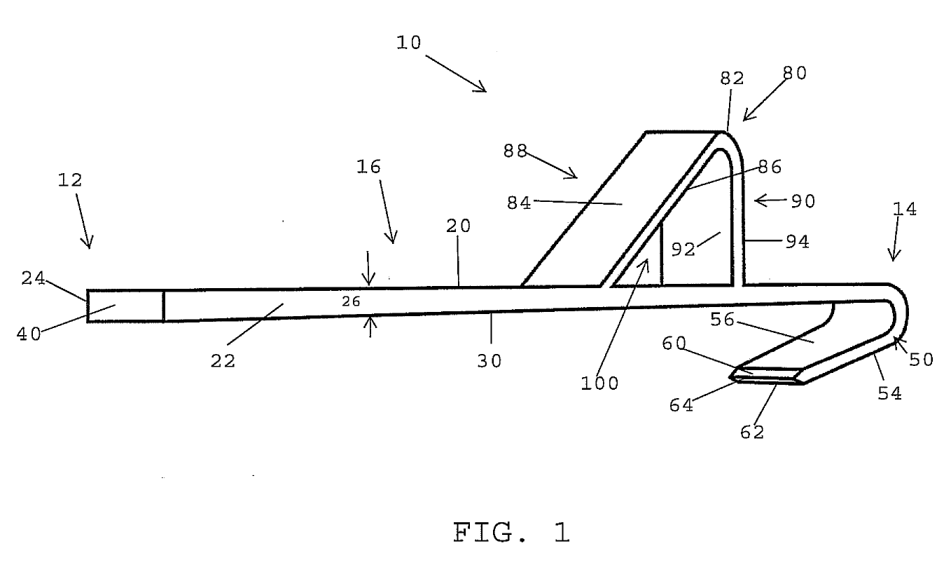

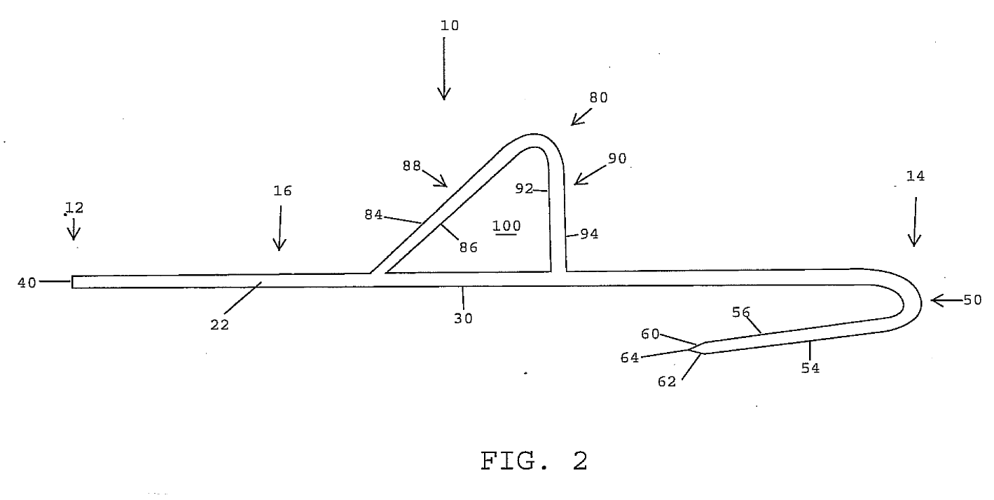

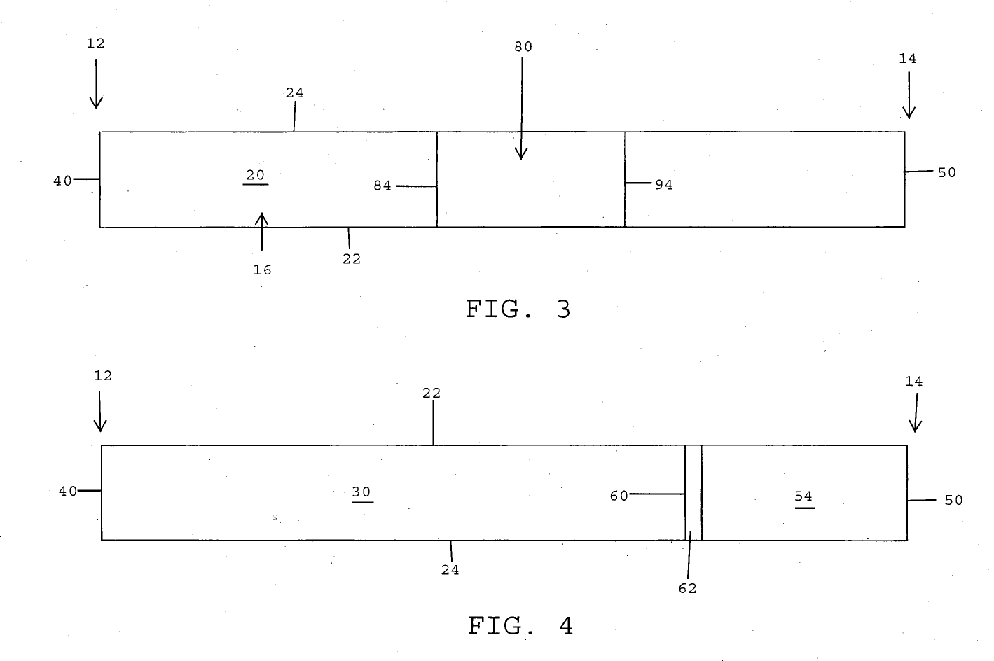

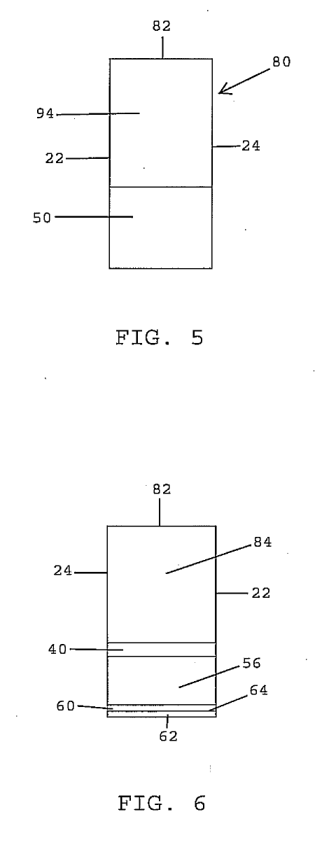

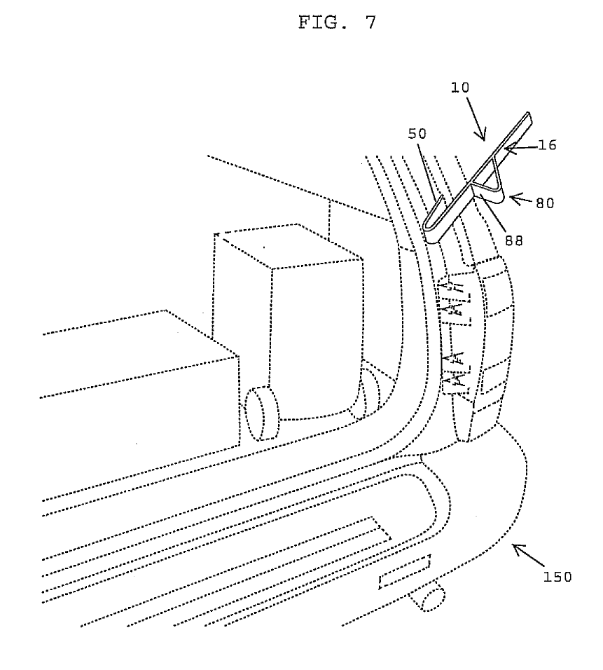

Referring to FIGS. 1-6, an auto body tool 10 constructed in accordance with the present invention is shown to include a shank 16, a first end 12, a second end 14, a shoulder 80, and a chisel 50. As will be discussed below with further detail, the auto body tool 10 is configured for placement of the beveled edges 60, 62 of the chisel 50 on the interior locations of an automobile's quarter panels where the metal layers meet. The auto body tool 10 is further configured so that once so placed, the shoulder 80 will be positioned in such a way that it a hammering force can be applied against it to help pry apart two metal sheets.

Referring to FIGS. 1-7, the auto body tool 10 is unitarily formed of a metal material of thickness 26. It shall be understood, however, that the auto body tool 10 can be constructed of steel, titanium, or another suitable material that will not deform when a hammering force is applied to the shoulder 80.

Referring to FIGS. 1-7, the auto body tool 10 is designed and configured to include an elongated shank 16. The shank 16 includes an upper surface 20, a lower surface 30, opposite thereto, a left side wall 24 perpendicular to the upper surface 20 and the lower surface 30, and a right side wall 22 opposite the left side wall 24.

Referring to FIGS. 1-7, the first end 12 of the auto body tool 10 includes distal edge 40. Distal edge 40 is substantially rectangular in cross section and is designed to be substantially orthogonal to both upper surface 20, and lower surface 30. Distal edge 40 is also designed to be substantially orthogonal also to both the left side wall 24 and right side wall 22. Distal edge 40 forms a blunt end to the shank 16 but alternatively could be formed from a tapered end.

Referring to FIGS. 1-7, the second end 14 is configured to include a chisel 50. The chisel 50 bends away from the upper surface 20 and toward the lower surface 30 forming an angle with the shank 16. Chisel 50 includes an outer surface 54, an inner surface 56, and a sharp edge 64. The sharp edge 64 of the chisel 50 is formed from two beveled surfaces 60, 62 which form approximately 45 degree angles with the interior and exterior surfaces 56, 54 respectively.

Still referring to FIGS. 1-7, auto body tool 10 also includes a hammering shoulder 80 which is located at a position slightly offset from the midpoint of the shank 16. The hammering shoulder 80 includes a slanted shoulder wall 88 that extends away from the upper surface 20 of the shank 16 in an inclined plane. Slanted shoulder wall 88 includes an exterior surface 84, and an interior surface 86, opposite thereto. The hammering shoulder 80 also includes a vertical shoulder wall 90 that extends away from the upper surface 20 of the shank 16 opposite the slanted wall 88, substantially perpendicularly from the upper surface 20 of the shank 16. Vertical shoulder wall 90 includes an exterior vertical wall 94 and an interior vertical wall 92. The slanted shoulder wall 88 meets the vertical shoulder wall 90 at heel 82. The hammering shoulder 80 forms an interior area cavity 100 with the shank 16 that is essentially a right triangle in cross section.

Referring to FIG. 7, the auto body tool 10 is shown positioned at an automobile's 150 rear quarter panel location as it could typically be used. It can be seen that hammering shoulder 80 is easily accessible for the application of a force against it by a hammer or other means on the vertical wall 88 of the hammering shoulder 80 while the chisel 50 is securely pressed against the metal layers at a desired location by the shank 16.

It will be understood that a person skilled in the art may make many variations and modifications without departing from the spirit and the scope of the present invention. For example, the auto body tool 10 could be used for other purposes than removing quarter panels. The shoulder 80 could be configured in various shapes of various heights. The shank 16 could be made of various overall lengths, either shorter or longer. Moreover, the chisel 50 could be formed to bend away from the shank at various angles and also be made of varying lengths. All such variations and modifications, including those discussed above, are intended to be included within the scope of the present invention as defined in the appended claims.

What is claimed is:

1. An auto body tool for removal of automobile quarter panels comprising: a shank, a first end, a second end, a chisel, and a shoulder, wherein said shank includes an upper surface, a lower surface opposite thereto, and wherein said shoulder substantially forms a triangle shape with said shank.

2. The auto body tool of claim 1 wherein said shank, said chisel, and said shoulder are unitarily formed.

3. The auto body tool of claim 1 wherein said chisel includes a rounded end, a first beveled surface, a second beveled surface and a chisel edge.

4. The auto body tool of claim 1 wherein said chisel extends outwardly from said shank of said auto body tool at an angle.

5. The auto body tool of claim 1 wherein said shoulder includes a slanted wall, a vertical wall and a heel, wherein said slanted wall includes an interior slanted surface and an exterior slanted surface opposite thereto, said vertical wall includes an interior vertical surface and an exterior vertical surface opposite thereto, said heel is rounded.

6. The auto body tool of claim 5 wherein said shoulder and said shank are configured to form a right triangle in shape.

7. The auto body tool of claim 1 wherein said first end is substantially orthogonal to said upper surface and said lower surface of said shank.

8. The auto body tool of claim 1 wherein said auto body tool is made of steel.
